(19) United States
(12) Patent Application Publication
(10) Pub. No.: US 2026/0259391 A1
(43) Pub. Date: Sep. 3, 2026

(54) LENS DEVICE AND CAMERA DEVICE INCLUDING SAME

(71) Applicant: LG ELECTRONICS INC., Seoul (KR)

(72) Inventor: Sangok YEO, Seoul (KR)

(73) Assignee: LG ELECTRONICS INC., Seoul (KR)

(21) Appl. No.: 19/159,912

(22) PCT Filed: Sep. 19, 2023
(86) PCT No.: PCT/KR2023/014154

§ 371 Date: Aug. 26, 2025

(30) Foreign Application Priority Data
Apr. 21, 2023 (KR) 10-2023-0052790

(51) Int. Cl. G02B 13/00

(52) U.S. Cl. CPC G02B 13/0045

(57) ABSTRACT

The present disclosure relates to a lens device which is capable of implementing high-resolution optical performance while reducing the lens size even when using a plastic material instead of a glass material in order to lower the manufacturing cost of the lens, and a camera device including the lens device, the lens device comprising: a front lens group, an aperture, and a rear lens group sequentially arranged in a direction from the object to the image sensor, wherein the front lens group has negative refractive power as a whole, and the rear lens group has positive refractive power as a whole, and the front lens group includes a first lens group having negative refractive power and having a front surface that is flat or convex toward the object, and a second lens group having positive refractive power and having a rear surface that is convex toward the image sensor, and when the composite focal length of the front lens group is f0 and the focal length of the first lens group is f1, |f0/f1|≥1.1.

### CROSS REFERENCE TO RELATED APPLICATIONS

This application is the National Phase of PCT International Application No. PCT/KR2023/014154, filed on Sep. 19, 2023, which claims priority under 35 U.S.C. 119 (a) to Patent Application No. 10-2023-0052790, filed in the Republic of Korea on Apr. 21, 2023, all of which are hereby expressly incorporated by reference into the present application.

### TECHNICAL FIELD

The present disclosure relates to a lens device and a camera device including the same, and more particularly, to a lens device capable of achieving high-resolution optical performance while reducing size and a camera device including the same.

### BACKGROUND

Lens devices are used in camera devices and deliver light from objects to image sensors

Meanwhile, among camera devices, small camera devices are used, for example, in medical endoscope devices.

Lens devices in camera devices used in medical endoscope devices tend to be smaller in size and have higher resolution.

Currently, lens devices in camera devices used in medical endoscope devices provide approximately High Definition (HD) video. However, the need for providing Full HD or higher video is increasing for diagnostic accuracy and reduction of reading time.

Accordingly, research is being conducted on camera devices and lens devices in the camera devices to provide Full HD or higher video.

Meanwhile, a lens device in a camera devices used in a medical endoscope device needs to have a small outer diameter (for example, about 5 mm or less), and since high resolution needs to be achieved within a limited size, the complexity of the optical design of the lens device increases. If the curvature radius of an ultra-small lens in the lens device is too small or too large, lens processing becomes difficult, and even if processing is possible, the manufacturing complexity increases, which causes a decrease in yield and an increase in cost. This becomes more significant when plastic material, instead of glass, is used to reduce the manufacturing cost of the lens (or for use in disposable lens endoscopes).

### DISCLOSURE

### Technical Problem

The present disclosure is proposed to solve the above-described problems. That is, the present disclosure aims to provide a lens device capable of achieving high-resolution optical performance while reducing the lens size, even when plastic material, instead of glass, is used to reduce the manufacturing cost of the lens, and a camera device including the same

### Technical Solution

To achieve the above objects, a lens device according to one aspect of the present disclosure is provided. The lens device includes: a front lens group; a stop; and a rear lens group. The front lens group, the stop, and the rear lens group are arranged in order from an object toward an image sensor. The front lens group has an overall negative refractive power, and the rear lens group has an overall positive refractive power. The front lens group includes: a first lens group having a negative refractive power and a front surface that is either flat or convex toward the object; and a second lens group having a positive refractive power and a rear surface that is convex toward the image sensor. In addition, |f0/f1|≥1.1 is satisfied, where f0 denotes a combined focal length of the front lens group and f1 denotes a focal length of the first lens group.

A rear surface of the first lens group may be concave toward the object.

A front surface of the second lens group may be concave toward the image sensor.

The first lens group and the second lens group may be made of a plastic material.

The rear lens group may include, in order from the object toward the image sensor: a third lens group having a positive refractive power; a fourth lens group having a negative refractive power; and a fifth lens group having a positive refractive power.

The third lens group, the fourth lens group, and the fifth lens group may be made of a plastic material.

The first lens group, the third lens group, and the fifth lens group may be made of APEL APL5014CL, and the second lens group and the fourth lens group may be made of PANLITE SP-3810.

At least one surface of front or rear surfaces of the first to fifth lens groups may be aspherical.

0.2≤|ts/TT|≤0.31 may be satisfied, where ts denotes a distance from the front surface of the first lens group to the stop and TT denotes a distance from the front surface of the first lens group to a sensing plane of the image sensor.

1.0≤h/(R−Δt)≤1.74 may be satisfied, where h denotes a maximum effective radius of a rear surface of the first lens group, R denotes a radius of curvature of the rear surface of the first lens group at a point corresponding to the maximum effective radius, and Δt denotes a distance between the point corresponding to the maximum effective radius and a center point of the rear surface of the first lens group.

The front surface of the first lens group may be convex toward the object.

The front surface of the first lens group may be spherical.

Each of the first to fifth lens groups may include a single lens.

Front surfaces of the third and fifth lens groups may be convex toward the object, rear surfaces of the third and fifth lens groups may be convex toward the image sensor, a front surface of the fourth lens group may be concave toward the image sensor, and a rear surface of the fourth lens group may be concave toward the object.

### Advantageous Effects

The effects of a lens device and a camera device including the same according to the present disclosure are as follows.

According to at least one aspect of the present disclosure, a lens device and a camera device including the same may be implemented to achieve high-resolution optical performance while reducing the lens size, even when plastic material, instead of glass, is used to reduce the manufacturing cost of the lens.

According to at least one aspect of the present disclosure, the spacing pitch of a plurality of lens elements uniformly arranged in a lens array provided in a light source module may be minimized, thereby allowing the light source module to output illumination with uniform brightness over a wider area compared to the conventional case.

### BRIEF DESCRIPTION OF THE DRAWINGS

FIG. 1 illustrates a schematic exploded view of a camera device according to one aspect of the present disclosure.

FIG. 2 is a cross-sectional view of a lens device in the direction of an optical axis according to one aspect of the present disclosure.

FIG. 3 illustrates an example of lens data of the lens device of FIG. 2.

FIG. 4 illustrates aberrations of first to fifth rays for the lens device of FIG. 2.

FIG. 5 illustrates spherical aberration, astigmatism, and distortions for the lens device of FIG. 2.

FIG. 6 illustrates a Modulation Transfer Function (MTF) of the first to fifth rays for the lens device of FIG. 2.

FIG. 7 illustrates a modification of the lens device of FIG. 2.

FIG. 8 illustrates an example of lens data of the lens device of FIG. 7.

FIG. 9 illustrates aberrations of first to fifth rays for the lens device of FIG. 7.

FIG. 10 illustrates spherical aberrations, astigmatism, and distortions for the lens device of FIG. 7.

FIG. 11 illustrates an MTF of the first to fifth rays for the lens device of FIG. 7.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

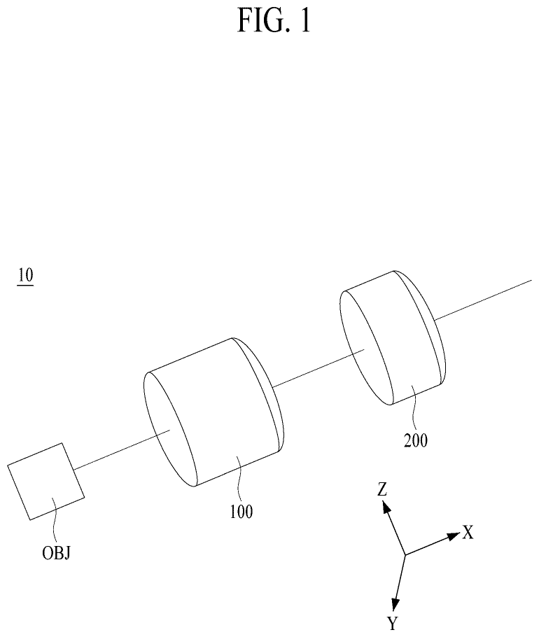

Hereinafter, a camera device will be briefly described with reference to FIG. 1. FIG. 1 illustrates a schematic exploded view of a camera device according to one aspect of the present disclosure.

Referring to FIG. 1, a camera device 10 according to one aspect of the present disclosure includes a lens device 100 and an image sensor 200 that converts light from the lens device 100 into an electrical signal.

The lens device 100 may receive light from an object OBJ in front, and the image sensor 200 may convert the light received by the lens device 100 into an electrical signal.

When the camera device 10 according to one aspect of the present disclosure is used in an endoscope, it is preferable that the diameter of the lens device 100 or a lens in the lens device 100 is 5 mm or 5.5 mm or less.

When the lens in the lens device 100 is an ultra-small lens, lens processing becomes difficult. Alternatively, even if lens processing is possible, the manufacturing complexity increases, which leads to a decrease in yield and an increase in manufacturing cost. In particular, the manufacturing complexity becomes more significant when a plastic-based material is used instead of glass to reduce the manufacturing cost of the lens.

Meanwhile, considering the case where the camera device 10 is used in an endoscope, it is preferable to achieve high resolution within a limited size.

Accordingly, the present disclosure proposes the lens device 100 that is capable of achieving high-resolution optical performance while reducing size, even when a plastic-based material is used as the lens material, and is capable of ensuring short manufacturing time and stable yield through an injection molding method.

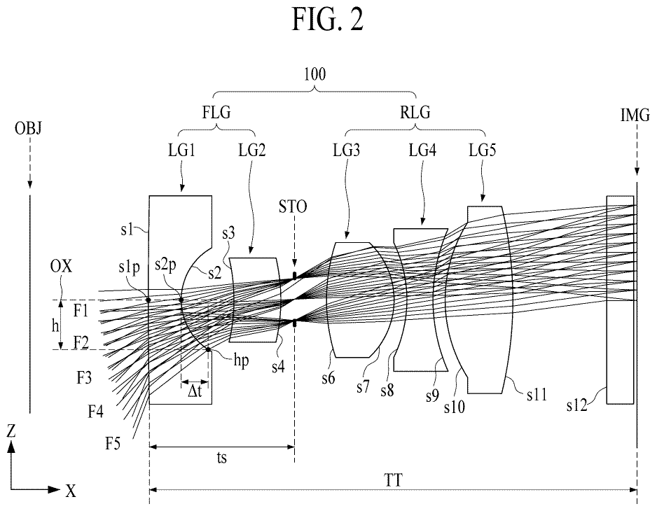

FIG. 2 is a cross-sectional view of the lens device in the direction of the optical axis OX according to one aspect of the present disclosure.

The lens device 100 according to one aspect of the present disclosure may be disposed between an object (or object plane) OBJ and an image sensor (or image sensing plane) IMG. The lens device 100 may include a front lens group FLG, a stop STO, and a rear lens group RLG in order from the object OBJ toward the image sensor IMG.

The front lens group FLG may include a first lens group LG1 and a second lens group LG2 in order from the object OBJ toward the image sensor IMG.

The rear lens group RLG may include a third lens group LG3, a fourth lens group LG4, and a fifth lens group LG5 in order from the object OBJ toward the image sensor IMG.

Each of the first lens group LG1 to the fifth lens group LG5 may be composed of a single lens element or a plurality of lens elements. Accordingly, the term “group” is used for the first lens group LG1 to the fifth lens group LG5.

Each of the first lens group LG1 to the fifth lens group LG5 may have lens characteristics that are symmetrical with respect to the optical axis OX.

The front lens group FLG may have an overall negative refractive power, and the rear lens group RLG may have an overall positive refractive power. Individually, the first lens group LG1 and the fourth lens group LG4 may each have a negative refractive power, and the second lens group LG2, the third lens group LG3, and the fifth lens group LG5 may each have a positive refractive power.

In FIG. 2, as light incident on the lens device 100 from the object OBJ, first to fifth rays F1 to F5 are illustrated from the center of the lens device 100 toward the outer direction.

A front surface s1 of the first lens group LG1 may be convex toward the object OBJ, and a rear surface s2 of the first lens group may be concave toward the object OBJ. In the present disclosure, “front” refers to the direction toward the object OBJ, and “rear” may refer to the direction toward the image sensing plane IMG.

That is, the front surface s1 of the first lens group LG1 may be shaped such that the central region thereof is closer to the object OBJ than the edge region thereof. Similarly, the rear surface s2 of the first lens group LG1 may also be shaped such that the central region thereof is closer to the object OBJ than the edge region thereof. Nevertheless, the reason why the front surface s1 of the first lens group LG1 is described as “convex” toward the object OBJ and the rear surface s2 of the first lens group LG1 is described as “concave” toward the object OBJ is because the front surface s1 and the rear surface s2 refer to opposite sides of the first lens group LG1, respectively.

In FIG. 2, it should be noted that although the front surface s1 of the first lens group LG1 may appear flat at first glance due to the large curvature radius, the front surface s1 of the first lens group LG1 is actually not a flat surface but a curved surface.

Meanwhile, a front surface s3 of the second lens group LG2 may be concave toward the image sensing plane IMG, and a rear surface s4 of the second lens group LG2 may be convex toward the image sensing plane IMG.

That is, the front surface s3 of the second lens group LG2 may be shaped such that the central region thereof is closer to the image sensing plane IMG than the edge region thereof. Similarly, the rear surface s4 of the second lens group LG2 may also be shaped such that the central region thereof is closer to the image sensing plane IMG than the edge region thereof. Nevertheless, the reason why the front surface s3 of the second lens group LG2 is described as “concave” toward the image sensing plane IMG and the rear surface s4 of the second lens group LG2 is described as “convex” toward the image sensing plane IMG is because the front surface s3 and the rear surface s4 refer to opposite sides of the second lens group LG2, respectively.

Front surfaces s6 and s10 of the third lens group LG3 and fifth lens group LG5 may be convex toward the object, and rear surfaces s7 and s11 of the third lens group LG3 and fifth lens group LG5 may be convex toward the image sensor. A front surface s8 of the fourth lens group LG4 may be concave toward the image sensor, and a rear surface s9 of the fourth lens group LG4 may be concave toward the object.

As described above, each of the first lens group LG1 to the fifth lens group LG5 may be manufactured by injection molding using a plastic material. For example, the first lens group LG1, the third lens group LG3, and the fifth lens group LG5 may be made of APEL APL5014CL (54620.560), and the second lens group LG2 and the fourth lens group LG4 may be made of PANLITE SP-3810 (64610.230). The numbers in parentheses, including decimal points, represent the material of the lens, which will be explained below.

Hereinafter, before describing the lens characteristics of the lens device 100, terms will be defined as follows.
f0: The combined focal length of the front lens group
f1: The focal length of the first lens group
h: The maximum effective radius of the rear surface s2 of the first lens group LG1 from the optical axis OX
hp: The point at which the maximum effective radius meets the rear surface s2 of the first lens group
R: The radius of curvature at the point of the maximum effective radius
s1p: The front center point on the front surface s1 of the first lens group LG1 that meets the optical axis OX and is closest to the object OBJ in the direction of the optical axis OX
s2p: The rear center point on the rear surface s2 of the first lens group LG1 that meets the optical axis OX and is closest to the object OBJ in the direction of the optical axis OX
Δt: The distance along the optical axis OX from the point of the maximum effective radius (hp) to the rear center point (s2p)
ts: The distance along the optical axis OX from the front center point (slp) to the stop STO
TT: The distance along the optical axis OX from the front center point (slp) to the image sensing plane IMG

To reduce the overall lens length (TT) and minimize the lens aperture size (for example, to Φ 5 mm or less), it is necessary to strengthen the power of the front lens group while shortening the stop distance (ts). However, this may cause lens aberrations and lead to degradation in Modulation Transfer Function (MTF) performance.

Accordingly, the lens characteristics may satisfy Equation 1 below.

$$\vert f 0 / f 1 \vert \geq 1. 1 \qquad [ Equation 1 ]$$

If the lower limit of Equation 1 is not satisfied, lens aberrations deteriorate due to the increased refractive power of the first lens group LG1 and the second lens group LG2, and the performance of the MTF is degraded.

Accordingly, it is preferable to increase the refractive power of each of the first lens group LG1 and the second lens group LG2, while optimizing an air gap between the rear surface s2 of the first lens group LG1 and the front surface s3 of the second lens group LG2 along the optical axis OX.

Therefore, in determining the power of the combined focal length (f0) of the front lens group FLG, it is preferable to consider |f0/f1|≥1.1.

Accordingly, it is possible to improve lens aberrations caused by the increased refractive power of the first lens group LG1 and the second lens group LG2, and to achieve high-resolution (FHD) optical performance without degradation of the MTF performance.

In addition, the lens characteristics may further satisfy Equation 2 below.

$$0.2 \leq \vert ts / TT \vert \leq 0.31 \qquad [ Equation 2 ]$$

If the upper limit of Equation 2 is exceeded, the refractive power of the front lens group FLG becomes weak, which may provide stability in terms of overall optical performance and manufacturing tolerance. However, the lens aperture size increases. To improve the performance of the outermost field, the rear surface s2 of the first lens group LG1 may take on a shape close to a hemisphere, which is disadvantageous for the miniaturization and mass production of medical endoscopes.

If the lower limit of Equation 2 is not satisfied, the refractive power of the front lens group FLG becomes increasingly stronger, which may further reduce the overall lens length (i.e., distance from the image sensing plane (TT)). However, aberrations increase rapidly, and the sensitivity to lens manufacturing tolerance also increases, which degrade mass production yield and quality control

In addition, the lens characteristics may satisfy Equation 3 below.

$$1. \leq h / ( R - Δ t ) \leq 1.74 \qquad [ Equation 3 ]$$

If the upper limit of Equation 3 is exceeded, the curvature shape of the rear surface s2 of the first lens group LG1 becomes close to a hemispherical shape, which leads to poor moldability of the lens. In addition, the shape of the edge portion of the curvature radius may fall outside the control standard, resulting in difficulty in ensuring quality.

In addition, if the lower limit of Equation 3 is not satisfied, it is possible to implement a lens shape with excellent moldability. However, to achieve an ultra-wide angle of view (FOV: Field of View) of 140 degrees or more required for endoscopes, the number of lens elements increases and the overall size of the lens increases, resulting in limitations in miniaturization.

When the lens device 100 is designed such that at least one of the conditions (Equation 1 to Equation 3) is satisfied as described above, it is possible to achieve high-resolution optical performance while reducing the lens size, even if each of the first lens group LG1 to the fifth lens group LG5 is manufactured by injection molding using a plastic material.

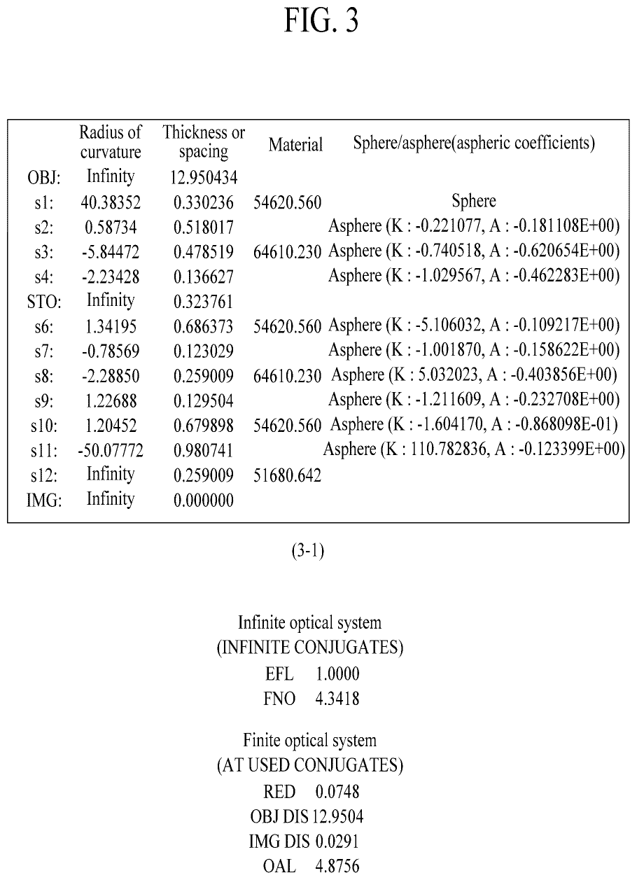

Hereinafter, lens data of the lens device 100 satisfying Equation 1 to Equation 3 will be described with reference to FIG. 3. FIG. 3 illustrates an example of lens data of the lens device of FIG. 2.

First, (3-1) of FIG. 3 will be described.

The first column on the far left represents a plurality of surfaces related to the characteristics of the lens device 100. The plurality of surfaces may include the object plane OBJ, the front surface s1 and rear surface s2 of the first lens group LG1, the front surface s3 and rear surface s4 of the second lens group LG2, the stop surface STO, the front surface s6 and rear surface s7 of the third lens group LG3, the front surface s8 and rear surface s9 of the fourth lens group LG4, the front surface s10 and rear surface s11 of the fifth lens group LG5, a front surface s12 of a cover glass of the image sensor 200, and the image sensing plane IMG.

The second column represents the radius of curvature at each surface.

The third column represents the thickness or spacing from each surface to the next surface along the optical axis OX. The unit is millimeters (mm).

The fourth column represents the material of a lens corresponding to each surface in numerical form. The value to the left of the decimal point indicates the refractive index, and the value to the right of the decimal point indicates the dispersion.

The fifth column indicates whether each surface is a spherical surface or an aspherical surface. In the case of an aspherical surface, the aspheric coefficients (K and A) for the aspheric equation are shown in parentheses.

Next, (3-2) of FIG. 3 will be described.

EFL (Effective Focal Length) represents an effective focal length. FNO (F Number) indicates an aperture value determined by the stop STO. RED (Reduction Ratio) represents a ratio between the object size and the image size. OBJ DIS (Object Distance) indicates a distance (unit:mm) between the front surface s1 of the first lens group LG1 and the object plane OBJ. IMG DIS (Image Distance) indicates a distance (unit:mm) between a rear surface of the cover glass of the image sensor 200 and the image sensing plane IMG. OAL (Overall Length) represents a distance between the front surface s1 of the first lens group LG1 and the rear surface of the cover glass of the image sensor 200. ANG (Angle) represents a maximum effective light incident angle to the first lens group LG1.

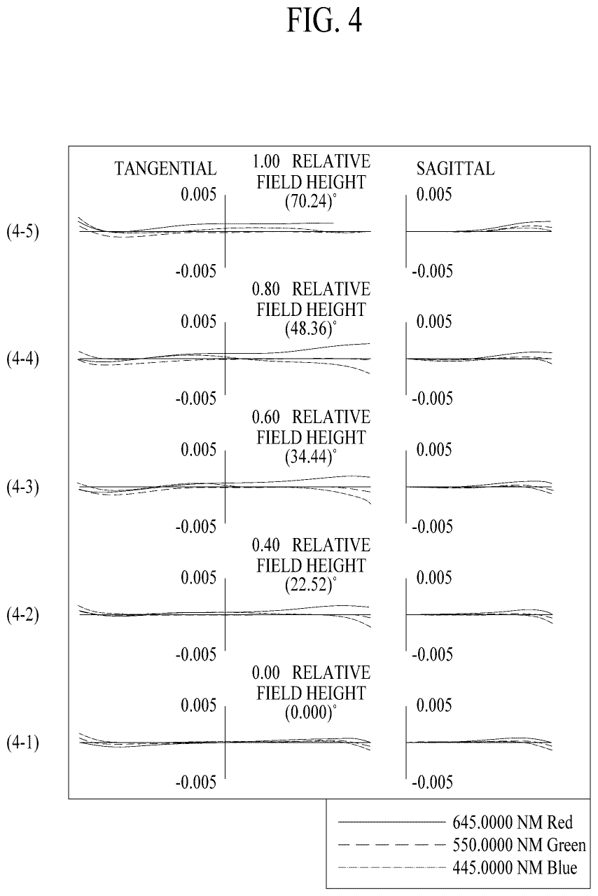

Hereinafter, the performance of the lens device of FIG. 2 will be described with reference to FIGS. 4 to 6. Here, the performance of the lens device of FIG. 2 corresponds to the case in which all of Equations 1 to 3 are satisfied.

FIG. 4 illustrates aberrations of the first to fifth rays F1 to F5 for the lens device of FIG. 2.

Specifically, (4-1) to (4-5) of FIG. 4 respectively show the aberrations for the tangential and sagittal planes of blue light, red light, and green light for the first to fifth rays F1 to F5.

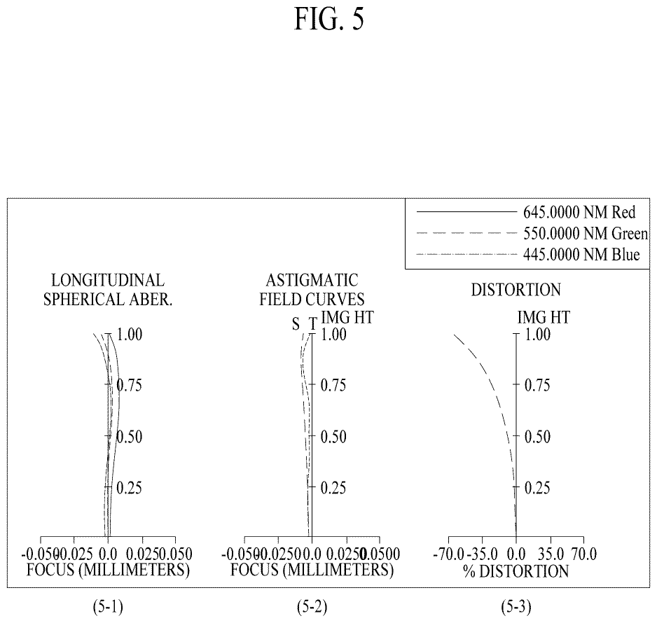

FIG. 5 illustrates spherical aberration, astigmatism, and distortions for the lens device of FIG. 2.

Specifically, (5-1) of FIG. 5 shows spherical aberrations, which represent the degree to which the focal positions of paraxial and marginal rays differ when light travels parallel to the optical axis at the center of the lens. In particular, (5-1) of FIG. 5 shows spherical aberration for blue light, red light, and green light.

Specifically, (5-2) of FIG. 5 shows astigmatism, which represents the degree to which the focal points in the tangential and sagittal planes deviate when light originating from an off-axis position passes through the lens. In particular, (5-2) of FIG. 5 shows astigmatism for green light.

Specifically, (5-3) of FIG. 5 shows distortions, which represent the degree to which magnification varies depending on the FOV region. In particular, (5-3) of FIG. 5 shows distortions for green light.

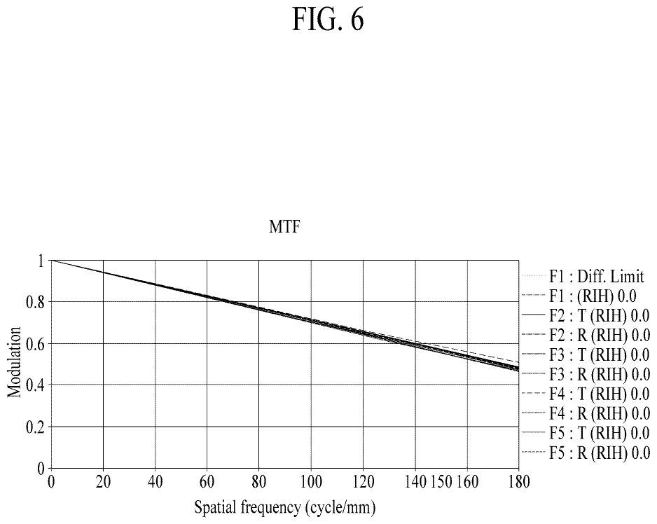

FIG. 6 illustrates the MTF of the first to fifth rays F1 to F5 for the lens device of FIG. 2.

Referring to FIG. 6, the horizontal axis represents spatial frequency (cycles/mm), and the vertical axis represents modulation.

FIG. 6 shows that the modulation of the lens device 100 changes according to changes in resolution (i.e., spatial frequency). Referring to FIG. 6, although the modulation of the lens device 100 generally decreases as the resolution increases, it is seen that the difference in modulation among the first to fifth rays F1 to F5 is minimal.

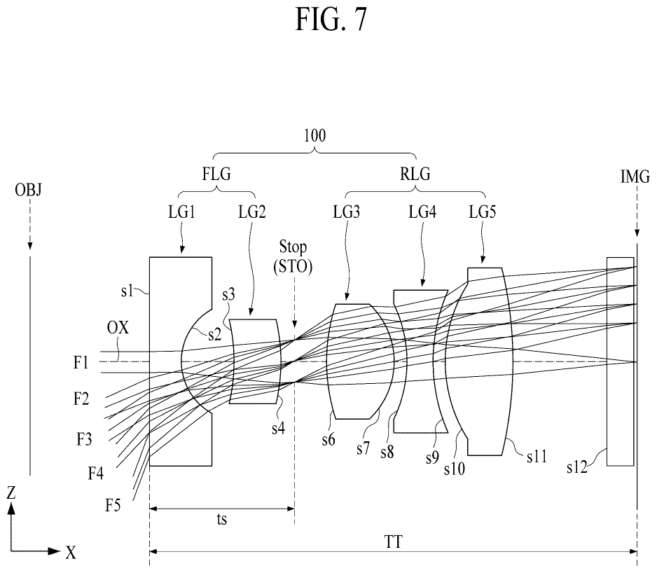

It has been described that the front surface s1 of the first lens group LG1 in the lens device of FIG. 2 is designed to be convex toward the object OBJ. However, the present disclosure is not limited thereto. The front surface s1 of the first lens group LG1 may also be designed to be a flat surface. This will be further described with reference to FIG. 7. FIG. 7 is a cross-sectional view of a lens device in the direction of an optical axis OX according to one aspect of the present disclosure. The lens device in FIG. 7 is a variation of the lens device of FIG. 2.

The lens device 100 according to one aspect of the present disclosure may be disposed between an object (or object plane) OBJ and an image sensor (or image sensing plane) IMG. The lens device 100 may include a front lens group FLG, a stop STO, and a rear lens group RLG in order from the object OBJ toward the image sensor IMG

The front lens group FLG may include a first lens group LG1 and a second lens group LG2 in order from the object OBJ toward the image sensor IMG.

The rear lens group RLG may include a third lens group LG3, a fourth lens group LG4, and a fifth lens group LG5 in order from the object OBJ toward the image sensor IMG.

Each of the first lens group LG1 to the fifth lens group LG5 may be composed of a single lens element or a plurality of lens elements. Accordingly, the term “group” is used for the first lens group LG1 to the fifth lens group LG5.

Each of the first lens group LG1 to the fifth lens group LG5 may have lens characteristics that are symmetrical with respect to the optical axis OX.

The front lens group FLG may have an overall negative refractive power, and the rear lens group RLG may have an overall positive refractive power. Individually, the first lens group LG1 and the fourth lens group LG4 may each have a negative refractive power, and the second lens group LG2, the third lens group LG3, and the fifth lens group LG5 may each have a positive refractive power.

In FIG. 7, as light incident on the lens device 100 from the object, first to fifth rays F1 to F5 are illustrated from the center of the lens device 100 toward the outer direction.

A front surface s1 of the first lens group LG1 may be flat, and a rear surface s2 of the first lens group may be concave toward the object OBJ. That is, a rear surface s2 of the first lens group LG1 may be shaped such that the central region thereof is closer to the object OBJ than the edge region thereof.

Meanwhile, a front surface s3 of the second lens group LG2 may be concave toward the image sensing plane IMG, and a rear surface s4 of the second lens group LG2 may be convex toward the image sensing plane IMG.

That is, the front surface s3 of the second lens group LG2 may be shaped such that the central region thereof is closer to the image sensing plane IMG than the edge region thereof. In addition, the rear surface s4 of the second lens group LG2 may also be shaped such that the central region thereof is closer to the image sensing plane IMG than the edge region thereof, similar to the front surface s3. Nevertheless, the reason why the front surface s3 of the second lens group LG2 is described as “concave” toward the image sensing plane IMG and the rear surface s4 of the second lens group LG2 is described as “convex” toward the image sensing plane IMG is because the front surface s3 and the rear surface s4 refer to opposite sides of the second lens group LG2, respectively.

Front surfaces s6 and s10 of the third lens group LG3 and fifth lens group LG5 may be convex toward the object, and rear surfaces s7 and s11 of the third lens group LG3 and fifth lens group LG5 may be convex toward the image sensor. A front surface s8 of the fourth lens group LG4 may be concave toward the image sensor, and a rear surface s9 of the fourth lens group LG4 may be concave toward the object.

As described above, each of the first lens group LG1 to the fifth lens group LG5 may be manufactured by injection molding using a plastic material. Specifically, the first lens group LG1, the third lens group LG3, and the fifth lens group LG5 may be made of APEL APL5014CL (54620.560), and the second lens group LG2 and the fourth lens group LG4 may be made of PANLITE SP-3810 (64610.230).

Hereinafter, before specifically describing the lens characteristics of the lens device 100, terms will be defined as follows.
f0: The combined focal length of the front lens group
f1: The focal length of the first lens group
ts: The distance along the optical axis OX from the front surface s1 of the first lens group to the stop STO
TT: The distance along the optical axis OX from the front surface s1 of the first lens group to the image sensing plane IMG

The lens characteristics satisfy Equation 1 as described above and may further satisfy Equation 2. The effects of the case in which the lens characteristics satisfy both Equation 1 and Equation 2 are as previously described.

When the lens device 100 is designed such that at least one of the conditions (at least one of Equation 1 and Equation 2) is satisfied as described above, it is possible to achieve high-resolution optical performance while reducing the lens size, even if each of the first lens group LG1 to the fifth lens group LG5 is manufactured by injection molding using a plastic material.

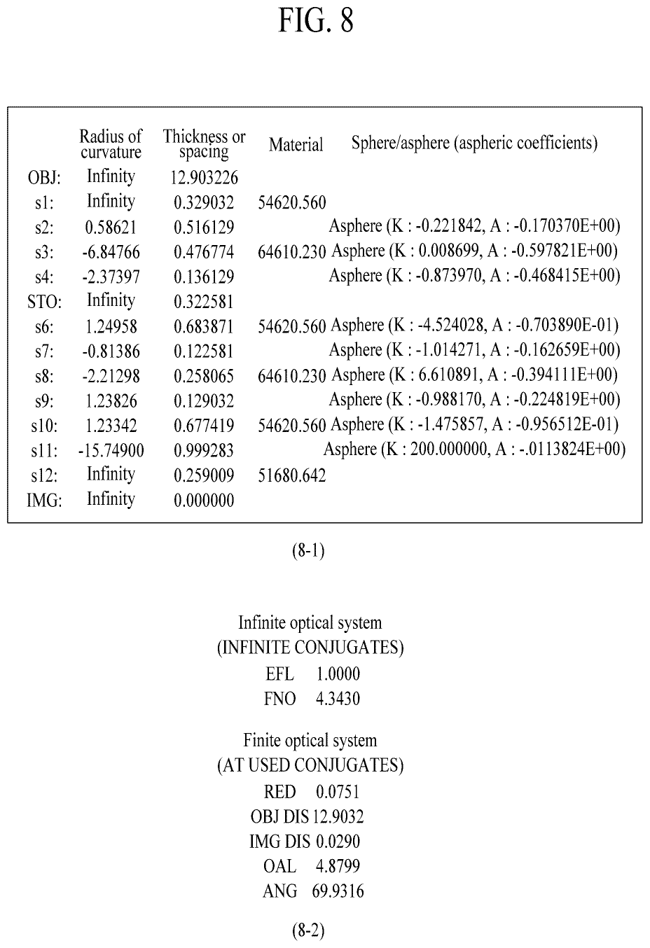

Hereinafter, lens data of the lens device 100 satisfying Equation 1 and Equation 2 will be described with reference to FIG. 8. FIG. 8 illustrates an example of lens data of the lens device of FIG. 7.

First, (8-1) of FIG. 8 will be described.

The first column on the far left represents a plurality of surfaces related to the characteristics of the lens device 100. The plurality of surfaces may include the object plane OBJ, the front surface s1 and rear surface s2 of the first lens group LG1, the front surface s3 and rear surface s4 of the second lens group LG2, the stop surface STO, the front surface s6 and rear surface s7 of the third lens group LG3, the front surface s8 and rear surface s9 of the fourth lens group LG4, the front surface s10 and rear surface s11 of the fifth lens group LG5, a front surface s12 of a cover glass of the image sensor 200, and the image sensing plane IMG.

The second column represents the radius of curvature at each surface.

The third column represents the thickness or spacing from each surface to the next surface along the optical axis OX. The unit is millimeters (mm).

The fourth column represents the material of a lens corresponding to each surface in numerical form. The value to the left of the decimal point indicates the refractive index, and the value to the right of the decimal point indicates the dispersion.

The fifth column indicates whether each surface is a spherical surface or an aspherical surface. In the case of an aspherical surface, the aspheric coefficients (K and A) for the aspheric equation are shown in parentheses.

Next, (8-2) of FIG. 8 will be described.

EFL (Effective Focal Length) represents an effective focal length. FNO (F Number) indicates an aperture value determined by the stop STO. RED (Reduction Ratio) represents a ratio between the object size and the image size. OBJ DIS (Object Distance) indicates a distance (unit:mm) between the front surface s1 of the first lens group LG1 and the object plane OBS. IMG DIS (Image Distance) indicates a distance (unit:mm) between a rear surface of the cover glass of the image sensor 200 and the image sensing plane IMG. OAL (Overall Length) represents a distance between the front surface s1 of the first lens group LG1 and the rear surface of the cover glass of the image sensor 200. ANG (Angle) represents a maximum effective light incident angle to the first lens group LG1.

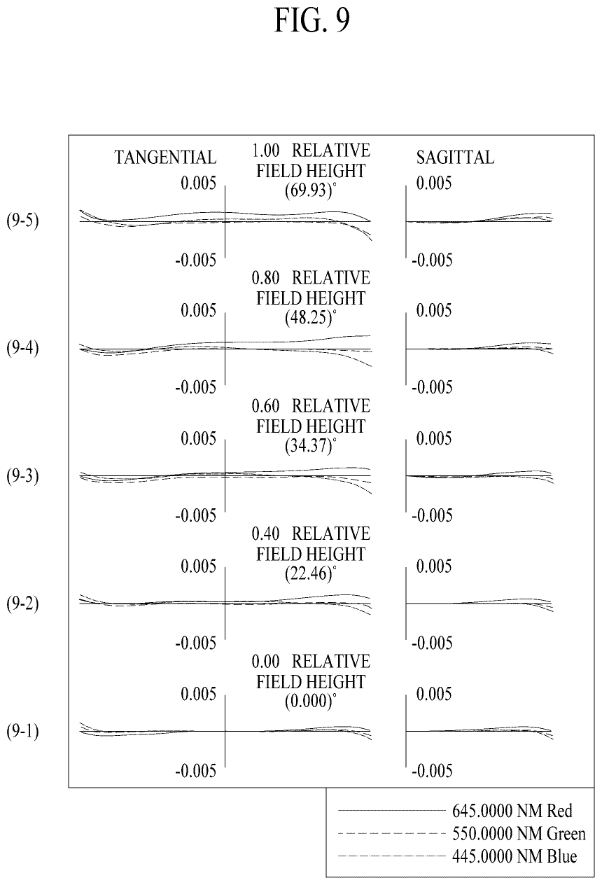

Hereinafter, the performance of the lens device of FIG. 7 will be described with reference to FIGS. 9 to 11. Here, the performance of the lens device in FIG. 7 corresponds to the case in which both Equation 1 and Equation 2 are satisfied.

FIG. 9 illustrates aberrations of the first to fifth rays F1 to F5 for the lens device of FIG. 7.

Specifically, (9-1) to (9-5) of FIG. 9 respectively show the aberrations for the tangential and sagittal planes of blue light, red light, and green light for the first to fifth rays F1 to F5.

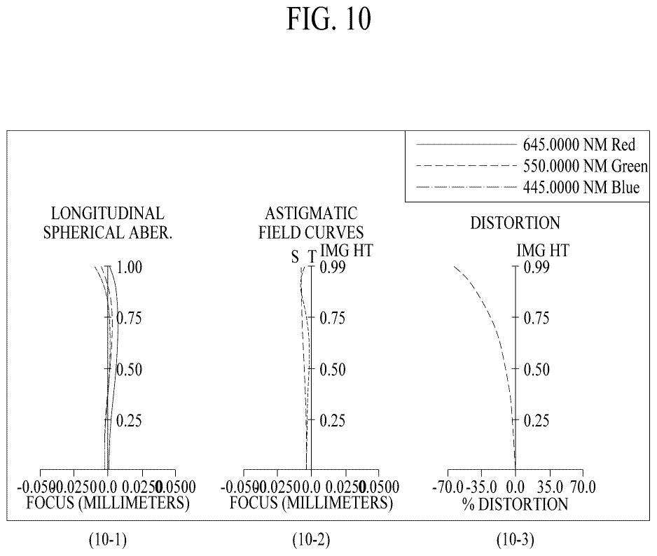

FIG. 10 illustrates spherical aberrations, astigmatism, and distortions for the lens device of FIG. 7.

Specifically, (10-1) of FIG. 10 shows spherical aberrations, which represent the degree to which the focal positions of paraxial and marginal rays differ when light travels parallel to the optical axis at the center of the lens. In particular, (10-1) of FIG. 10 shows spherical aberrations for blue light, red light, and green light.

Specifically, (10-2) of FIG. 10 shows astigmatism, which represents the degree to which the focal points in the tangential and sagittal planes deviate when light originating from an off-axis position passes through the lens. In particular, (10-2) of FIG. 10 shows astigmatism for green light.

Specifically, (10-3) of FIG. 10 shows distortions, which represent the degree to which magnification varies depending on the FOV region. In particular, (10-3) of FIG. 10 shows distortions for green light.

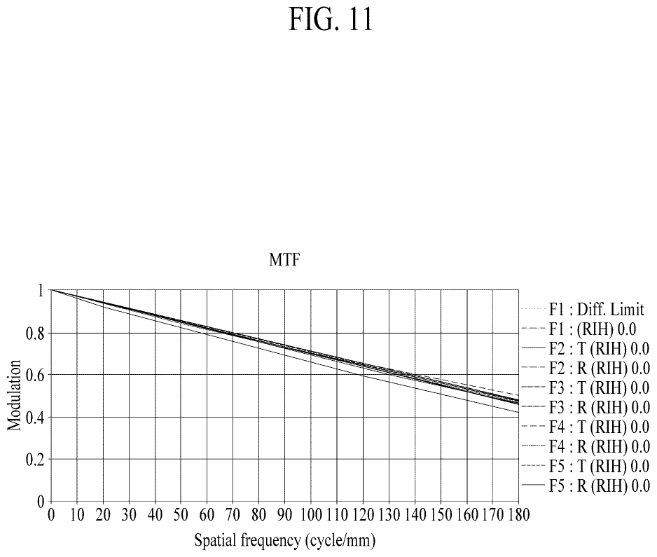

FIG. 11 illustrates the performance of the MTF of the first to fifth rays F1 to F5 for the lens device of FIG. 7.

Referring to FIG. 11, the horizontal axis represents spatial frequency (cycles/mm), and the vertical axis represents modulation.

FIG. 11 shows that the modulation of the lens device 100 changes according to changes in resolution (i.e., spatial frequency). Referring to FIG. 6, although the modulation of the lens device 100 generally decreases as the resolution increases, it is seen that the difference in modulation among the first to fifth rays F1 to F5 is minimal. However, comparing the lens device of FIG. 7 with the lens device of FIG. 2, it may be seen that the MTF performance of the lens device of FIG. 2 is generally slightly superior.

The above detailed description should not be construed in a limiting sense in all respects but should be considered as illustrative. The scope of the present disclosure should be determined by the reasonable interpretation of the appended claims, and all modifications within the equivalent scope of the present disclosure are included within the scope of the present disclosure.

1. A lens device comprising:
a front lens group;
a stop; and
a rear lens group,
wherein the front lens group, the stop, and the rear lens group are arranged in order from an object toward an image sensor,
wherein the front lens group has an overall negative refractive power,
wherein the rear lens group has an overall positive refractive power,
wherein the front lens group comprises:
a first lens group having a negative refractive power and a front surface that is either flat or convex toward the object; and
a second lens group having a positive refractive power and a rear surface that is convex toward the image sensor, and
wherein |f0/f1|≥1.1 is satisfied, where f0 denotes a combined focal length of the front lens group and f1 denotes a focal length of the first lens group.

2. The lens device of claim 1, wherein a rear surface of the first lens group is concave toward the object.

3. The lens device of claim 1, wherein a front surface of the second lens group is concave toward the image sensor.

4. The lens device of claim 1, wherein the first lens group and the second lens group are made of a plastic material.

5. The lens device of claim 4, wherein the rear lens group comprises, in order from the object toward the image sensor:
a third lens group having a positive refractive power;
a fourth lens group having a negative refractive power; and
a fifth lens group having a positive refractive power.

6. The lens device of claim 5, wherein the third lens group, the fourth lens group, and the fifth lens group are made of a plastic material.

7. The lens device of claim 6, wherein the first lens group, the third lens group, and the fifth lens group are made of APEL APL5014CL, and
wherein the second lens group and the fourth lens group are made of PANLITE SP-3810.

8. The lens device of claim 5, wherein at least one surface of front or rear surfaces of the first to fifth lens groups is aspherical.

9. The lens device of claim 1, wherein 0.2≤|ts/TT|≤0.31 is satisfied, where ts denotes a distance from the front surface of the first lens group to the stop and TT denotes a distance from the front surface of the first lens group to a sensing plane of the image sensor

10. The lens device of claim 1, wherein 1.0≤h/(R−Δt)≤1.74 is satisfied, where h denotes a maximum effective radius of a rear surface of the first lens group, R denotes a radius of curvature of the rear surface of the first lens group at a point corresponding to the maximum effective radius, and Δt denotes a distance between the point corresponding to the maximum effective radius and a center point of the rear surface of the first lens group.

11. The lens device of claim 10, wherein the front surface of the first lens group is convex toward the object.

12. The lens device of claim 10, wherein the front surface of the first lens group is spherical.

13. The lens device of claim 5, wherein each of the first to fifth lens groups comprises a single lens.

14. The lens device of claim 5, wherein front surfaces of the third and fifth lens groups are convex toward the object,
wherein rear surfaces of the third and fifth lens groups are convex toward the image sensor,
wherein a front surface of the fourth lens group is concave toward the image sensor, and
wherein a rear surface of the fourth lens group is concave toward the object.
